(19) United States
(12) Patent Application Publication
(10) Pub. No.: US 2019/0378056 A1
(43) Pub. Date: Dec. 12, 2019

(54) ACCOMMODATION VEHICLE MANAGING DEVICE, ACCOMMODATION VEHICLE MANAGING SYSTEM, AND ACCOMMODATION VEHICLE

(71) Applicant: TOYOTA JIDOSHA KABUSHIKI KAISHA, Toyota-shi (JP)

(72) Inventors: Shoya SATO, Tokyo-To (JP); Katsuya TERAHATA, Susono-shi (JP); Yushi SEKI, Ashigarakami-gun (JP)

(73) Assignee: TOYOTA JIDOSHA KABUSHIKI KAISHA, Toyota-shi (JP)

(21) Appl. No.: 16/424,600

(22) Filed: May 29, 2019

(30) Foreign Application Priority Data
Jun. 12, 2018 (JP) 2018-111822

(51) Int. Cl. G06Q 10/02; G06Q 50/12; G06K 9/00

(52) U.S. Cl. CPC G06Q 10/02; G06K 9/00838; G06Q 50/12

(57) ABSTRACT

An accommodation vehicle management apparatus includes a transmitter/receiver configured to communicate with an accommodation vehicle where one or more guests may stay overnight; a processor comprising hardware, wherein the processor is configured to determine whether an actual number of guests in the accommodation vehicle is less than or equal to a predetermined number of guests who are allowed to utilize the accommodation vehicle by using bedding, and output an allowance signal indicating allowance of usage of the bedding to the accommodation vehicle through the transmitter/receiver when it is determined that the actual number of guests in the accommodation vehicle is less than or equal to the redetermined number of guests.

### CROSS-REFERENCE TO RELATED APPLICATION(S)

The present application claims priority to and incorporates by reference the entire contents of Japanese Patent Application No. 2018-111822 filed in Japan on Jun. 12, 2018.

### BACKGROUND

The present disclosure relates to an accommodation vehicle managing device, an accommodation vehicle managing system, and an accommodation vehicle.

Japanese Laid-open Patent Publication No. 2017-191371 A (referred to as JP 2017-191371 A) discloses an autonomous vehicle capable of automatic driving. In such a vehicle, authentication reference information on a user registrant preliminarily registered as a person who is planning to use the vehicle is stored in association with identification information of the user registrant, and schedule information of the scheduled use of the vehicle is stored in association with each piece of the identification information of the user registrant. JP 2017-191371 A also discloses that a vehicle having an adequate capacity with respect to the number of passengers informed in advance can be assigned to a scheduled user.

Here, the current standards for the space and facility in an establishment for common lodging house operation according to the Order for Enforcement of the Japanese Inns and Hotels Act provides for a regulation regarding the area of a guest room that, in the case where less than ten guests are staying, the area has to be larger than or equal to an area obtained by multiplying 3.3 square meters by the number of guests. Therefore, the number of guests who can stay is determined depending on the total floor areas of guest rooms. Moreover, in a common lodging house, it is also required to maintain a guest list by means such as registering or electromagnetic recording. However, staying overnight in the vehicle is not assumed (hereinafter referred to as “in-vehicle overnight stay”) in the technique described in JP 2017-191371 A, and thus no consideration has been made to the aforementioned standards for the space and facility. Therefore, in the case of accommodation vehicles in which in-vehicle overnight stay is possible, there is still a room for further improvement.

The present disclosure has been made in view of the above, and an object of the present disclosure is to provide an accommodation vehicle managing device and accommodation vehicle managing system capable of performing operation conforming to the Order for Enforcement of the Inns and Hotels Act in an accommodation vehicle, and the accommodation vehicle.

### SUMMARY

According to a first aspect of the present disclosure, an accommodation vehicle management apparatus is provided. The accommodation vehicle management apparatus includes a transmitter/receiver configured to communicate with an accommodation vehicle where one or more guests may stay overnight; a processor comprising hardware, wherein the processor is configured to-determine whether an actual number of guests in the accommodation vehicle is less than or equal to a predetermined number of guests who are allowed to utilize the accommodation vehicle by using bedding, and output an allowance signal indicating allowance of usage of the bedding to the accommodation vehicle through the transmitter/receiver when it is determined that the actual number of guests in the accommodation vehicle is less than or equal to the predetermined number of guests.

According to a second aspect of the present disclosure, an accommodation vehicle management system is provided. The accommodation vehicle management system includes an accommodation vehicle where one or more guests may stay overnight; and an accommodation vehicle management apparatus configured to manage operation of the accommodation vehicle, the accommodation vehicle management apparatus including: a transmitter/receiver configured to communicate with the accommodation vehicle; and a processor comprising hardware, wherein the processor is configured to determine whether an actual number of guests in the accommodation vehicle is less than or equal to a predetermined number of guests who are allowed to utilize the accommodation vehicle by using bedding, and output an allowance signal indicating allowance of usage of the bedding to the accommodation vehicle through the transmitter/receiver when it is determined that the actual number of guests in the accommodation vehicle is less than or equal to the predetermined number of guests.

According to a third aspect of the present disclosure, an accommodation vehicle where one or more guests may stay overnight is provided. The accommodation vehicle includes a processor comprising hardware, wherein the processor is configured to determine whether an actual number of guests in the accommodation vehicle is less than or equal to a predetermined number of guests who are allowed to utilize the accommodation vehicle by using bedding, and output an allowance signal indicating allowance of usage of the bedding to an input/output device provided in the accommodation vehicle, when it is determined that the actual number of guests in the accommodation vehicle is less than or equal to the predetermined number of guests.

The above and other objects, features, advantages and technical and industrial significance of this disclosure will be better understood by reading the following detailed description of presently preferred embodiments of the disclosure, when considered in connection with the accompanying drawings.

### BRIEF DESCRIPTION OF THE DRAWINGS

FIG. 1 is a schematic-diagram illustrating a vehicle assignment system to which an accommodation vehicle managing device according to an embodiment of the present disclosure can be applied;

FIG. 2 is a block diagram schematically illustrating a configuration of the accommodation vehicle managing device illustrated in FIG. 1;

FIG. 3 is a table illustrating exemplary data of charge information stored in an operation management database of the accommodation vehicle managing device;

FIG. 4 is a block diagram schematically illustrating a configuration of a parking lot managing center illustrated in FIG. 1;

FIG. 5 is a block diagram schematically illustrating the main configuration of the vehicles illustrated in FIG. 1;

FIG. 6 is a block diagram schematically illustrating a configuration of an accommodation function switching unit in a control unit of a vehicle terminal device mounted in the vehicles illustrated in FIG. 5;

FIG. 7 is a block diagram schematically illustrating a configuration of an identity verifying unit in a control unit of the vehicle terminal device mounted in the vehicle illustrated in FIG. 5;

FIG. 8 is a block diagram schematically illustrating a configuration of a user terminal device illustrated in FIG. 1;

FIG. 9 is a flowchart for explaining a processing method by the vehicle assignment system;

FIG. 10 is a flowchart for explaining a method of generating an operation plan illustrated in FIG. 9;

FIG. 11 is a flowchart for explaining a processing method for confirming the number of guests according to an embodiment of the present disclosure; and

FIG. 12 is a flowchart for explaining a processing method for identity verification the illustrated in FIG. 11.

### DETAILED DESCRIPTION

Hereinafter, an embodiment of the present disclosure will be described with reference to the drawings. Note that, in all the following drawings of one embodiment, the same symbols are assigned to the same or corresponding parts. Moreover, the present disclosure is not limited by one embodiment described below.

Vehicle Managing System

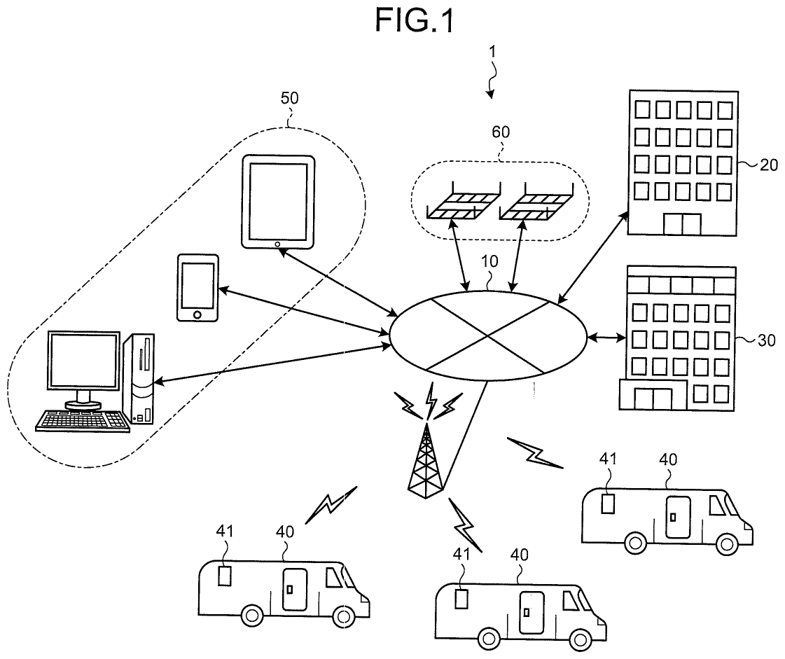

First, a vehicle managing device according to an embodiment of the present disclosure will be described. FIG. 1 is a schematic diagram illustrating a vehicle managing system 1 as an accommodation vehicle managing system to which the vehicle managing device according to the embodiment-can be applied. As illustrated in FIG. 1, the vehicle managing system 1 according to this embodiment includes a network 10, a vehicle managing device 20, a parking lot managing center 30, vehicles 40 each including a vehicle terminal device 41, and user terminal devices 50. The network 10 includes the Internet line network, a cellular phone line network, or other networks that allow communication among the vehicle managing device 20, the parking lot managing center 30, the vehicles 40, and the user terminal devices 50. That is, in the vehicle managing system 1 according to the embodiment, the vehicle managing device 20, the parking lot managing center 30, the respective vehicles 40, and the user terminal devices 50 are connected via the network 10 so as to be communicable with one another.

Vehicle Managing Device

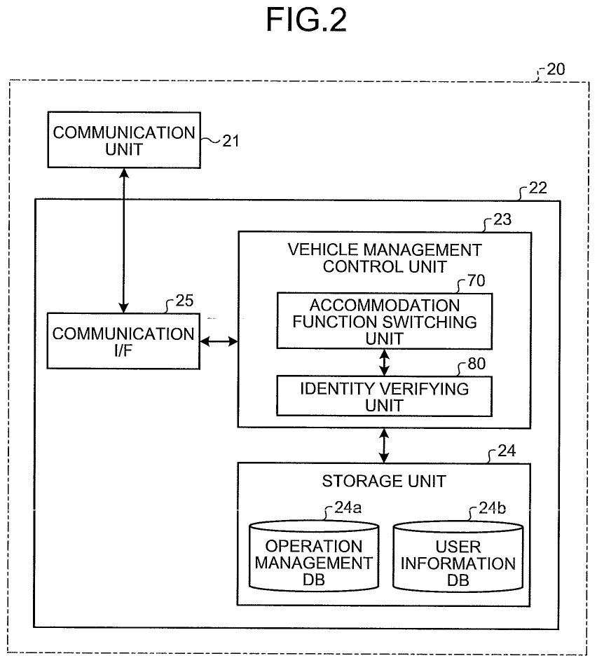

The vehicle managing device 20, as an accommodation vehicle managing unit, generates an operation schedule of the vehicles 40 in accordance with requests (demands) of users and determines an operation plan. The vehicle managing device 20 further provides the operation plan information to the vehicles 40 to manage the operation. The vehicle managing device 20 provides the operation plan information to the users and also provides various types of information related to the operation of the vehicles 40. FIG. 2 is a block diagram schematically illustrating a configuration of the vehicle managing device 20.

As illustrated in FIG. 2, the vehicle managing device 20 includes a communication unit 21 and a server 22. The communication unit 21 is connected with the server 22 via a communication line configured in the vehicle managing device 20. The communication unit 21 connects to the network 10 to perform communication with the parking lot managing center 30, the vehicle terminal devices 41, and the user terminal devices 50.

The communication unit 21 transmits the operation plan information to, and receives vehicle identification information and operation state information from the vehicle terminal device 41. Note that the vehicle identification information includes information for allowing the vehicles 40 to be separately identified. The operation state information includes information indicating the operation state such as positional information and speed information regarding the operation of the vehicles 40. The communication unit 21 receives reservation state information from, and transmits parking reservation information to the parking lot managing center 30. The reservation state information includes information on whether a parking lot 60 is available. The parking reservation information includes information for reserving a date and time of parking and a parking position in the parking lot 60. The communication unit 21 transmits information to a user terminal device 50 owned by a user when a vehicle 40 is used, and receives user identification information for identifying the user or various types of information from the user terminal device 50.

The server 22 includes a vehicle management control unit 23, a storage unit 24, and a communication interface (I/F) 25. The vehicle management control unit 23 is configured with the main components thereof being a microcomputer including a central processing unit (CPU), a read only memory (ROM), a random access memory (RAM), etc. The vehicle management control unit 23, as an operation management unit, comprehensively controls the operations of the vehicle managing device 20, particularly the server 22, related to determination of the operation plans and the operation management. The vehicle management control unit 23 further includes an accommodation function switching unit 70 and an identity verifying unit 80. The accommodation function switching unit 70 and the identity verifying unit 80 are configured to allow input and output of information with each other. Note that details of the accommodation function switching unit 70 and the identity verifying unit 80 will be described later. The storage unit 24 includes a storage medium such as a hard disk and a semiconductor memory and a drive device for driving such storage medium, and stores various programs and various types of data in a writable and readable manner.

The storage unit 24 includes an operation management database (DB) 24a and a user information database (DB) 24b. In the operation management database 24a, user identification information and various types of information necessary for use of the vehicle 40 by the user (hereinafter also referred to as user selection information) are stored in association with each other in a retrievable manner. In the operation management database 24a, vehicle identification information and operation state information are stored in association with each other in a retrievable manner. The vehicle identification information includes information for identifying the vehicle 40. Such information can be transmitted from the vehicle terminal device 41 mounted on the vehicle 40. The user information database 24b stores the user identification information, the vehicle identification information, and information related to a user (hereinafter referred to as a guest) scheduled to use the vehicle 40 as an accommodation (hereinafter referred to as guest information) in association with each other in a retrievable manner. The guest information includes the maximum number of guests who can be accommodated in the vehicle 40, the number of guests who use the vehicle 40 as an accommodation requested by the user, and the nationality of each of the guests. The communication interface 25 is for connection with a network line such as a local area network line configured within the vehicle managing device 20.

The user identification information and the vehicle identification information are stored in the operation management database 24a and the user information database 24b in a retrievable manner when assigned to the user and the vehicle 40, respectively. The user identification information is registered in association with the name and address of the user and positional information such as the longitude and the latitude representing the position of the user, for example. When a user transmits predetermined information together with user identification information using the user terminal device 50, for example, the user identification information and the predetermined information are stored in association with each other in a retrievable manner in the operation management database 24a and the user information database 24b of the storage unit 24. Similarly, when the vehicle terminal device 41 transmits predetermined information such as positional information and vehicle information together with vehicle identification information, the vehicle identification information and the predetermined information are stored in association with each other at a retrievable storage position in the operation management database 24a. The vehicle information includes information such as a state of charge (SOC) of a battery, a remaining amount of fuel (fuel remaining amount), the current position, a list of insufficient items but is not necessarily limited to such information. Note that details of the user information database 24b will be described later.

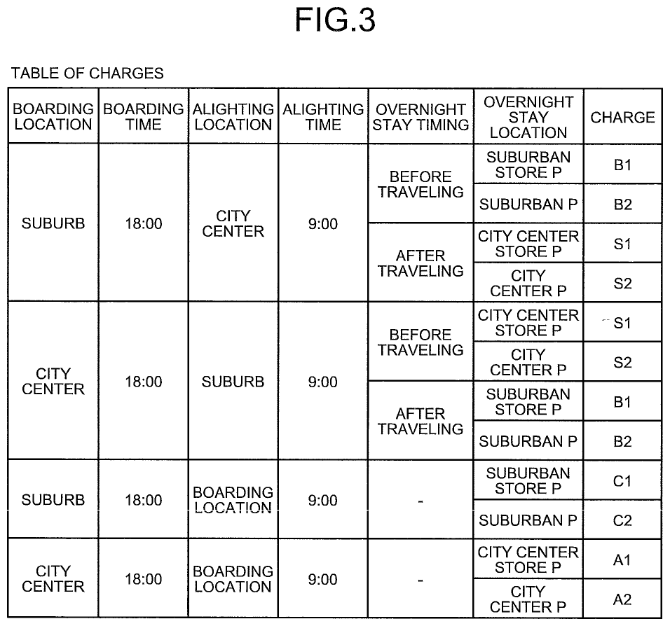

The operation management database 24a stores data of charge information. FIG. 3 is a table illustrating exemplary data of charge information used in the embodiment. As illustrated in FIG. 3, the charge information includes information of boarding locations, boarding time, alighting locations, alighting time, overnight stay timings, overnight stay locations, and charges. Note that the charge information is not limited to the above. For example, the charge information may include information such as boarding dates, alighting dates, or major roads used in an operation plan. Details of the contents of the charge information will be described later.

Parking Lot Managing Center

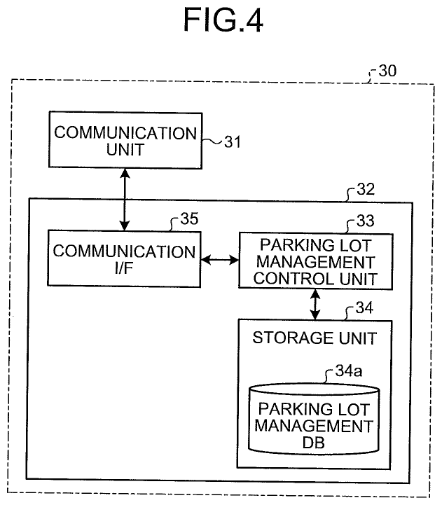

The parking lot managing center 30 is capable of retrieving the availability of the parking lots 60 at various locations in accordance with an operation plan of a vehicle 40. The parking lot managing center 30 makes a reservation for parking for each of the parking lots. FIG. 4 is a block diagram schematically illustrating a configuration of the parking lot managing center 30.

As illustrated in FIG. 4, the parking lot managing center 30 includes a communication unit 31 and a server 32. The communication unit 31 is connected with the server 32 via a communication line configured in the parking lot managing center 30. The communication unit 31 connects to the network 10 and communicates mainly with the vehicle managing device 20 and managing devices of the parking lots 60 at various locations. The communication unit 31 receives vacancy status, that is, reservation state information of the parking lots 60 for each date and time from, and transmits parking reservation information for making a reservation for a date, time, period of time, etc. of using the parking lot 60 to the managing devices of the parking lots 60.

The server 32 includes a parking lot management control unit 33, a storage unit 34, and a communication interface (I/F) 35. The parking lot management control unit 33 is configured with the main components thereof being a microcomputer including a CPU, a ROM, a RAM, etc. The parking lot management control unit 33 comprehensively controls the operation of the parking lot managing center 30 which manages reservation state information and parking reservation information of the parking lots 60, particularly, the operation of the server 32. The storage unit 34 includes a storage medium such as a hard disk and a semiconductor memory and a drive device for driving such storage medium, and stores various programs and various types of data in a writable and readable manner.

The storage unit 34 includes a parking lot management database (DB) 34a. In the parking lot management database 34a, reservation state information of the parking lots 60 and other information are stored in association with parking lot identification information in a retrievable manner. The parking lot identification information includes information for identifying the parking lots 60 transmitted from the managing devices (not illustrated) of the parking lots 60 at various locations. Moreover, the parking lot identification information is registered in association with, for example, positional information of the longitude and the latitude, names of the parking lots 60, and the like. When a managing device of a parking lot 60 transmits parking lot information to the parking lot managing center 30, the parking lot identification information and the parking lot information are stored in a retrievable manner in association with each other in the parking lot management database 34a. The communication interface 35 is for connection with a network line such as a local area network (LAN) line configured within the parking lot managing center 30.

The parking lot managing center 30 receives parking lot information transmitted thereto from the managing devices of the respective parking lots 60 as necessary. The parking lot information includes at least positional information, battery charging facility information which is information whether there is a battery charging facility, and fueling facility information which is information whether there is a fueling facility capable of refueling in each of the parking lots 60. Additionally, the parking lot information may include, as necessary, reservation state information related to parking of the vehicle 40 or other vehicles, parking state information, and other information. Incidentally, the parking lot information may include other information such as name information or charge information of the parking lot.

Accommodation Vehicle

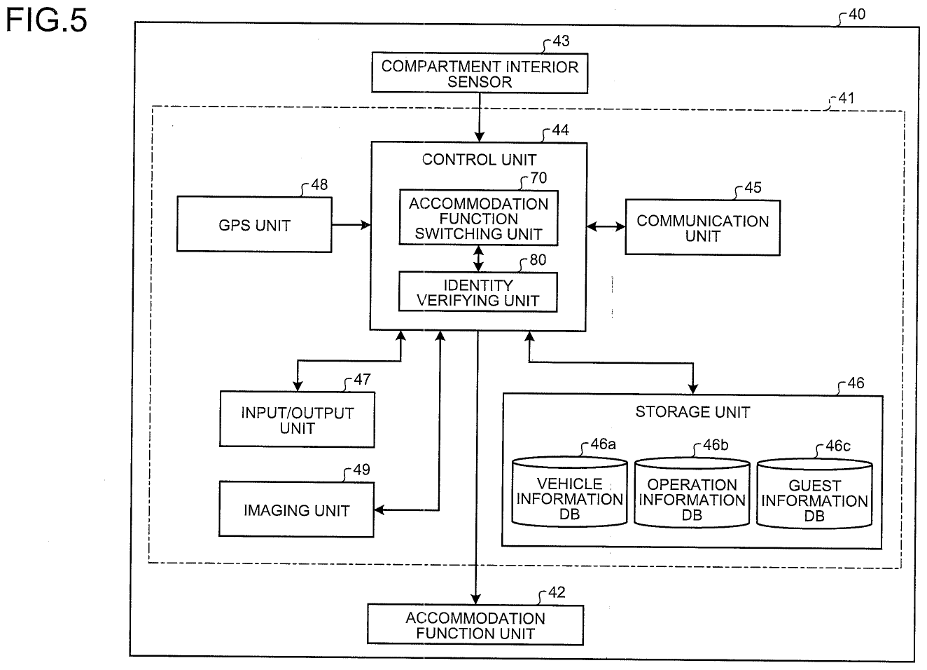

FIG. 5 is a block diagram schematically illustrating the main configuration of a vehicle 40. As illustrated in FIG. 5, the vehicle 40 includes at least the vehicle terminal device 41, an accommodation function unit 42, and a compartment interior sensor 43. The vehicle 40 is a so-called accommodation vehicle or lodging vehicle including the accommodation function unit 42 (serving as temporary living quarters) that allows staying overnight (hereinafter referred to as “in-vehicle overnight stay”) in the vehicle, such as a recreational vehicle, a motor home, and a camper.

Although not illustrated, the vehicle 40 includes conventionally known facilities necessary for traveling. Specifically, the vehicle 40 includes an engine as a driving source. The engine operates on fuel and drives a generator thereby to generate electric power. The generated electric power is charged in a rechargeable battery. The vehicle 40 further includes a drive transmission mechanism that transmits the driving force of the engine, driving wheels for traveling, etc.

The accommodation function unit 42 includes at least bedding such as a bed as well as various facilities accompanying as an accommodation such as water and sewage facilities. In one embodiment, the accommodation function unit 42 is in a use-restricted state in which use of the function for staying overnight is restricted unless predetermined conditions are satisfied in the vehicle 40. In other words, the accommodation function unit 42 can be used when the predetermined conditions are satisfied. Note that, in the current Inns and Hotels Act, “lodging” is defined as “to utilize the establishments by using bedding”.

The compartment interior sensor 43 is capable of detecting various states within the compartment of the vehicle 40. The compartment interior sensor 43 is preferably a sensor having a function particularly as a number-of-people confirming unit capable of confirming the number of people in the compartment of the vehicle 40 and may be, for example, an imaging camera, a temperature sensor, or the like. The compartment interior sensor 43 measures inside the compartment of the vehicle 40 continuously or intermittently at predetermined time intervals.

The vehicle 40 has no predetermined traveling route, traveling time, or the like (hereinafter referred to as an operation plan) but is an accommodation vehicle that travels in accordance with an operation plan determined by the vehicle managing device 20 as appropriate depending on requests or instructions by the user. Therefore, the vehicle 40 is provided with the vehicle terminal device 41 capable of transmitting and receiving various types of information including operation plan information through communication with the vehicle managing device 20. The vehicle terminal device 41 includes a control unit 44, a communication unit 45, a storage unit 46, an input/output unit 47, a GPS unit 48, and an imaging unit 49.

The communication unit 45 communicates with the vehicle managing device 20 by wireless communication via the network 10. The storage unit 46 includes a storage medium such as a hard disk and a semiconductor memory and a drive device for such storage media. The storage unit 46 as a storage unit stores programs of an operating system (OS) and various applications necessary for the control unit 44 to integrally control the operation of the vehicle terminal device 41. The storage unit 46 includes a vehicle information database (DB) 46a, an operation information database (DB) 46b, and a guest information database (DB) 46c. The vehicle information database 46a stores various types of information including a state of charge, a fuel remaining amount, the current position, a list of insufficient items, etc. in an updatable manner. The operation information database 46b stores various types of data including operation plan information provided from the vehicle managing device 20 in an updatable manner. The guest information database 46c stores guest information related to the guest who stays overnight in a predetermined vehicle 40 in association with user identification information and vehicle identification information in a retrievable manner. In this example, various types of data including the guest information related to the guest staying overnight in the predetermined vehicle 40 can be synchronized as appropriate in the guest information database 46c and the user information database 24b in accordance with predetermined rules. For example, each of the guest information database 46c and the user information database 24b can be synchronized with regard to guest information of guests using a predetermined vehicle 40, with various types of data stored in one of the databases including the latest guest information updating the various types of data of the other database.

The input/output unit 47 includes a touch panel display, a speaker microphone, and the like. The input/output unit 47 as an output unit is capable of externally notifying predetermined information such as operation plan information in accordance with control by the control unit 44 such as by displaying characters, figures, or the like on the screen of the touch panel display or outputting sound from the speaker microphone. The input/output unit 47 as an input unit is further configured to input predetermined information to the control unit 44 when a user or other people operates the touch panel display or utters a sound to the speaker microphone.

The GPS unit 48 receives a radio wave from global positioning system (GPS) satellites and detects the position of the vehicle 40 on which the vehicle terminal device 41 is mounted. The detected position is retrievably stored in the vehicle information database 46a as positional information in the vehicle information. The imaging unit 49 includes an imaging device such as a camera, an image reading device such as a scanner, or sensors capable of biometric authentication such as an iris sensor, a fingerprint sensor, or a regular pulse sensor. Note that a device capable of inputting voice data such as a microphone can be also included as necessary.

The control unit 44 of the vehicle terminal device 41 is configured with the main components thereof being a microcomputer including a CPU, a ROM, a RAM, etc. The control unit 44 integrally controls the operation of the vehicle terminal device 41 mounted on the vehicle 40.

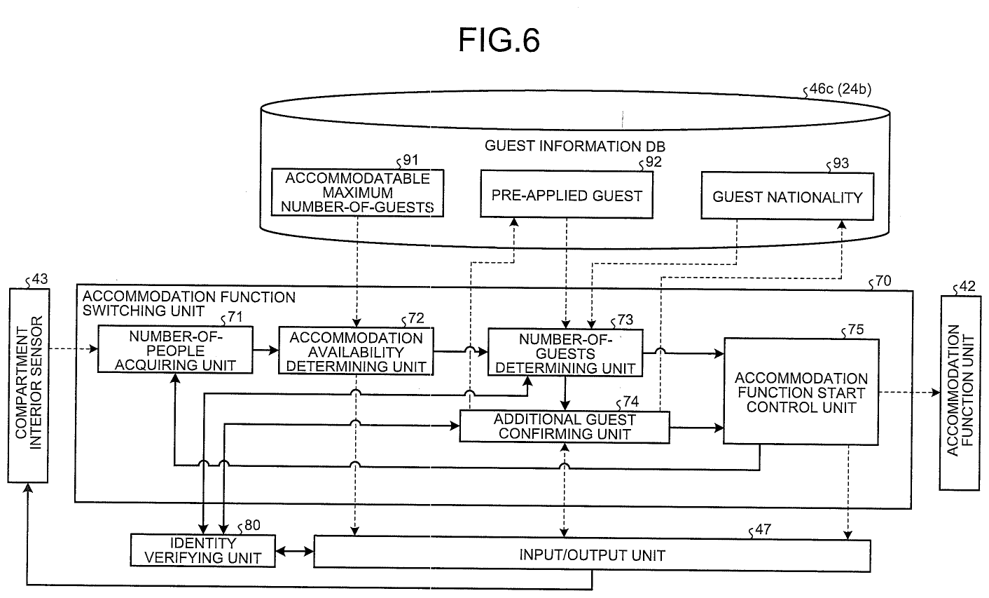

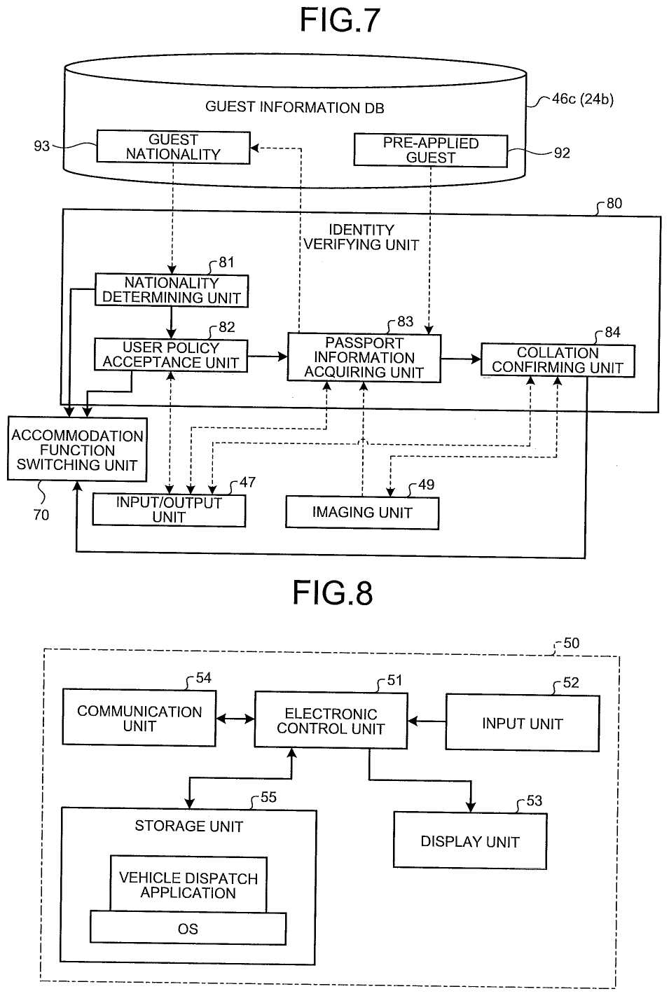

The control unit 44 further includes an accommodation function switching unit 70 and an identity verifying unit 80. The accommodation function switching unit 70 and the identity verifying unit 80 are capable of inputting and outputting various types of information therebetween. FIG. 6 and FIG. 7 are block diagrams schematically illustrating configurations of the accommodation function switching unit 70 and the identity verifying unit 80, respectively, in the control unit 44 of the vehicle terminal device 41 mounted in the vehicle 40. Note that, in the following description, processing in the accommodation function switching unit 70 and the identity verifying unit 80 of the control unit 44 of the vehicle terminal device 41 will be described as an example; however, processing in the accommodation function switching unit 70 and the identity verifying unit 80 of the vehicle management control unit 23 of the vehicle managing device 20 is also alike. In FIGS. 6 and 7, an arrow indicates input or output of data, information, signals, etc., and a dashed arrow indicates not only input or output of data, information, signals, etc. within the vehicle management control unit 23 or the control unit 44 but also input or output of data, information, signals, etc. between the vehicle 40 and the vehicle managing device 20 via the network 10.

Accommodation Function Switching System

As illustrated in FIG. 6, the accommodation function switching unit 70 according to one embodiment includes a number-of-people acquiring unit 71, an accommodation availability determining unit 72, a number-of-guests determining unit 73, an additional guest confirming unit 74, and an accommodation function start control unit 75.

The number-of-people acquiring unit 71 is supplied with measurement data of the number of people in the compartment from the compartment interior sensor 43 as the number-of-people confirming unit. The number-of-people acquiring unit 71 confirms the number of people in the compartment of the vehicle 40 on the basis of the supplied measurement data. The number-of-people acquiring unit 71 supplies the information of the confirmed number of people in the compartment (in-compartment number-of-people information) to the accommodation availability determining unit 72.

The accommodation availability determining unit 72 is supplied with accommodatable maximum number-of-guests information 91 stored in the quest information database 46c. The accommodatable maximum number-of-guests information 91 is information of the maximum number of people who can stay that is determined for each of the vehicles 40 in accordance with, for example, laws, ordinances, or regulations established in a place where the accommodation vehicle 40 is operated. The accommodation availability determining unit 72 determines whether the number of people in the compartment in the supplied in-compartment number-of-people information is less than or equal to the maximum number of people in the accommodatable maximum number-of-guests information 91. When it is determined that the number of people in the compartment is less than or equal to the maximum number of people, the accommodation availability determining unit 72 supplies, to the number-of-guests determining unit 73, a signal (accommodation provision signal) indicating that the number of people in the compartment is less than or equal to the maximum number of people as well as the in-compartment number-of-people information. On the other hand, when it is determined that the number of people in the compartment is larger than the maximum number of people, the accommodation availability determining unit 72 outputs externally a signal (accommodation denial signal) indicating that accommodation cannot be provided to the current number of people in the compartment. When the accommodation denial signal output by the accommodation availability determining unit 72 is supplied to the input/output unit 47, the input/output unit 47 displays on the touch panel display or outputs, by sound from the speaker microphone, information indicating that accommodation cannot be provided for the current number of people in the compartment. As a result, in the vehicle 40, it is notified externally, that is, to passengers in the vehicle 40 that accommodation cannot be provided for the current number of people in the compartment. Furthermore, the accommodation availability determining unit 72 supplies, to the vehicle managing device 20, the information indicating that the number of people in the compartment is larger than the maximum number of people as well as the accommodation denial signal via the network 10.

The number-of-guests determining unit 73 as a number-of-guests determining unit is supplied with pre-applied guest information 92 and guest nationality information 93 stored in the guest information database 46c The pre-applied guest information 92 includes information of the number of guests (applied number of guests) applied in advance for using the vehicle 40. The guest nationality information 93 includes information of the nationality of each of the guests. The number-of-guests determining unit 73 determines whether the number of people in the compartment in the in-compartment number-of-people information supplied from the accommodation availability determining unit 72 is less than or equal to the applied number of guests in the pre-applied guest information 92. When it is determined that the number of people in the compartment is less than or equal to the applied number of guests, the number-of-guests determining unit 73 supplies a verification request signal to the identity verifying unit 80 on the basis of the supplied guest nationality information 93. The identity verifying unit 80 to which the verification request signal has been supplied collates the passengers actually in the compartment of the vehicle 40 with the guests who were supposed to stay. Note that the method of identity verification by the identity verifying unit 80 will be described later. In the case where the collation with the guests can be confirmed by the identity verifying unit 80, the identity verifying unit 80 supplies a verification success signal to the number-of-guests determining unit 73. The number-of-guests determining unit 73 to which the verification success signal has been supplied supplies an accommodation provision signal to the accommodation function start control unit 75. On the contrary, in the case where the collation with the guests cannot be confirmed by the identity verifying unit 80, the identity verifying unit 80 supplies a verification failure signal to the number-of-guests determining unit 73. The number-of-guests determining unit 73 to which the verification failure signal has been supplied supplies an accommodation denial signal to the accommodation function start control unit 75.

Furthermore, when it is determined that the number of people in the compartment is greater than the applied number of guests, the number-of-guests determining unit 73 supplies the information indicating that the number of people in the compartment is greater than the applied number of guests to the vehicle managing device 20 via the network 10 and supplies the accommodation denial signal to the additional guest confirming unit 74. On the basis of the accommodation denial signal supplied from the number-of-guests determining unit 73, the additional guest confirming unit 74 supplies, to the input/output unit 47, accommodation denial information indicating that the current number of people in the compartment in the vehicle 40 is greater than the applied number of guests in the pre-applied guest information 92. Here, on the basis of the guest nationality information 93, the additional guest confirming unit 74 sets the language used in the information output from the input/output unit 47 as at least one of the official language and the second official language used in the country of the target guest's nationality depending on the nationality of the guest. Note that, as the language used in the information supplied from the accommodation function switching unit 70 and output to the input/output unit 47, languages corresponding to nationalities of the guests are used for the guests. Furthermore, even when the languages corresponding to the nationalities of the guests do not include English, information may be output in English as well as in the languages used.

The additional guest confirming unit 74 further supplies, to the input/output unit 47, guest addition information that allows the user to select whether to increase the number of guests. The input/output unit 47 to which various types of information has been supplied notifies the passengers of the vehicle 40 of the supplied accommodation denial information and the guest addition information in a similar manner as described above.

In the case where the user selects to increase the number of guests and inputs a selection of increase from the input/output unit 47, the additional guest confirming unit 74 supplies, to the input/output unit 47, information prompting to input information necessary for generation of a guest list conforming to laws and ordinances (or the Inns and Hotels Act) and notifies the user. When the user inputs information necessary for generation of a guest list for the number of people to be increased from the input/output unit 47, the additional guest confirming unit 74 stores the input information in the guest information database 46c and updates the pre-applied guest information 92 and the guest nationality information 93.

The additional guest confirming unit 74 supplies a verification request signal to the identity verifying unit 80 on the basis of the updated guest nationality information 93. The identity verifying unit 80 to which the verification request signal has been supplied collates the passengers in the compartment of the vehicle 40 with the guests who are supposed to stay, based on the updated information. In the case where the collation with the guests cannot be confirmed by the identity verifying unit 80, the identity verifying unit 80 supplies a verification failure signal to the additional guest confirming unit 74. The additional guest confirming unit 74 to which the verification failure signal has been supplied supplies an accommodation denial signal to the accommodation function start control unit 75. On the other hand, in the case where-the collation with the guests can be confirmed by the identity verifying unit 80, the identity verifying unit 80 supplies a verification success signal to the additional guest confirming unit 74. The additional guest confirming unit 74 to which the verification success signal has been supplied supplies an accommodation provision signal to the accommodation function start control unit 75.

When the accommodation provision signal is supplied from at least one of the number-of-guests determining unit 73 and the additional guest confirming unit 74, the accommodation function start control unit 75 as the accommodation function start unit supplies, to the accommodation function unit 42 of the vehicle 40, a use restriction release signal for releasing use restriction. The accommodation function unit 42, to which the use restriction release signal as a signal for allowing use of bedding has been supplied, enters a state in which various facilities necessary for staying overnight are available including the bedding. Meanwhile, the accommodation function start control unit 75 supplies, to the input/output unit 47, the information indicating that the use restriction of the accommodation function unit 42 has been released. The input/output unit 47 to which the information of use restriction release has been supplied notifies the passengers of the vehicle 40 of the information indicating that the use restriction of the accommodation function unit 42 has been released on the basis of the supplied information in a similar manner as described above. Furthermore, after releasing the use restriction of the accommodation function unit 42, the accomodation function start control unit 75 controls the number-of-people acquiring unit 71, periodically at predetermined time intervals or at every predetermined trigger, to count the number of people in the compartment of the vehicle 40. Here, as a predetermined trigger, a specific example may be a time when a door of the vehicle 40 is opened and closed.

Identity Verification System

Next, a description will be given on the accommodation function switching unit 70 configured as described above and the identity verifying unit 80 according to an embodiment configured to be capable of inputting and outputting various types of information. As illustrated in FIG. 7, the identity verifying unit 80 includes a nationality determining unit 81, a user policy acceptance unit 82, a passport information acquiring unit 83, and a collation confirming unit 84. Note that, as described above, the identity verifying unit 80 is supplied with a verification request signal for each guest from either the number-of-guests determining unit 73 or the additional guest-confirming unit 74.

The nationality determining unit 81 is supplied with the guest nationality information 93 related to the nationality of guests stored in the guest information database 46c. The nationality determining unit 81 determines whether the nationality of a guest staying overnight in the compartment of the vehicle 40 is that of the country in which the vehicle 40 is used on the basis of the supplied guest nationality information 93. In this embodiment, the nationality determining unit 81 determines whether the nationality of a guest as a subject of confirmation is the Japanese nationality or a foreign nationality. When it is determined that the guest has a foreign nationality on the basis of the guest nationality information 93, the nationality determining unit 81 supplies a foreign nationality collation signal to the user policy acceptance unit 82. On the other hand, when it is determined that the guest has the Japanese nationality on the basis of the guest nationality information 93, the nationality determining unit 81 outputs and supplies a verification success signal to either one, which has output the verification request signal, of the number-of-guests determining unit 73 and the additional guest confirming unit 74

The user policy acceptance unit 82 to which the foreign nationality collation-signal has been supplied supplies, to the input/output unit 47, information indicating the necessity of confirmation of the passport and verification of the identity in accordance with laws and ordinances as well as information inquiring whether to agree to presentation of the passport and disclosure of personal information and notifies a target guest. Here, the user policy acceptance unit 82 changes the language used in the information output from the input/output unit 47 depending on the nationality of the target guest having been determined by the nationality determining unit 81. Preferably, information is output from the input/output unit 47 using at least one of an official language and a second official language used in the country of the guest's nationality. Note that, as the language used in the information supplied from the identity verifying unit 80 and output to the input/output unit 47, languages corresponding to nationalities of the guests are used for the guests. Furthermore, even when the languages corresponding to the nationalities of the guests do not include English, information may be output in English as well as in the languages used. Furthermore, in the case where nationality information of the target guest is acquired from the passport information which will be described later, it is also possible to change the language used in the information output from the input/output unit 47 depending on the nationality of the guest based on the passport information.

In the case where the guest inputs information to the effect that he or she disagrees to presentation of the passport and disclosure of personal information by the input/output unit 47, the user policy acceptance unit 82 supplies the verification failure signal to either one, which has output the verification request signal, of the number-of-guests determining unit 73 and the additional guest confirming unit 74 of the accommodation function switching unit 70. In this case, the start of use of the accommodation function unit 42 is restricted. The user policy acceptance unit 82 also supplies the information indicating that the guest disagrees to presentation of the passport and disclosure of personal information to the vehicle managing device 20 via the network 10.

On the other hand, in the case where the guest inputs information to the effect that he or she agrees to presentation of the passport and disclosure of personal information by the input/output unit 47, the user policy acceptance unit 82 supplies a user policy agreement signal to the passport information acquiring unit 83. The passport information acquiring unit 83 notifies of information prompting to input passport information of the guest to the guest through the input/output unit 47. When the guest supplies the passport information to the passport information acquiring unit 83 using a camera, a scanner, an IC reader, or the like in the imaging unit 49, the passport information acquiring unit 83 acquires passport information required by laws or ordinances (or the Inns and Hotels Act) for generation of a guest list of guests having foreign nationalities such as a passport number on the basis of, for example, the passport information or other electronic information supplied from the imaging unit 49. The passport information acquired by the passport information acquiring unit 83 is stored as the guest nationality information 93 in the guest information database 46c and is also supplied to the collation confirming unit 84.

The collation confirming unit 84 determines whether the guest nationality information 93 of the guest in the pre-applied guest information 92 matches the nationality information in the input passport information. In the case where the nationality information of the guest in the pre-applied guest information 92 and the nationality information of the passport information do not match, a verification failure signal is supplied to either one, which has output the verification request signal, of the number-of-guests determining unit 73 and the additional guest confirming unit 74 of the accommodation function switching unit 70.

On the other hand, in the case where the nationality information of the guest in the pre-applied guest information 92 and the nationality information of the passport information match, information prompting provision of biometric authentication information necessary for predetermined biometric authentication by the imaging unit 49 is supplied to the input/output unit 47 and is notified to the target guest. Here, provision of biometric authentication information can be executed, specifically, by photographing a face, a retina, etc. by the imaging unit 49, for example. When an image of the face, a retina, an iris, etc. of the guest is photographed by the imaging unit 49, the imaging unit 49 supplies the biometric authentication information such as the photographed face image, the retina image, the iris image, etc. to the collation confirming unit 84. The collation confirming unit 84 compares the supplied photographed face image or the retina image with passport information to determine whether the supplied passport information is that of the photographed guest.

In the case where it is determined that the supplied passport information is not that of the photographed guest, the collation confirming unit 84 supplies a verification failure signal to either one, which has output the verification request signal, of the number-of-guests determining unit 73 and the additional guest confirming unit 74 of the accommodation function switching unit 70. The collation confirming unit 84 also supplies, for each guest, information indicating that the supplied passport information is not that of the photographed guest to the vehicle managing device 20 via the network 10. On the other hand, in the case where it is determined that the supplied passport information is that of the photographed guest, the collation confirming unit 84 supplies a verification success signal to either one, which has output the verification request signal, of the number-of-guests determining unit 73 and the additional guest confirming unit 74 of the accommodation function switching unit 70. Note that the determination as to whether the passport information is that of the guest supplied by the collation confirming unit 84 is not necessarily limited to the face image, the retina image, or the iris image, and various methods can be adopted as long as the method enables collation confirmation between the passport information and the guest such as using a fingerprint image or using the Social Security Number, Individual Number or the like.

Note that there are cases where the vehicle 40 cannot get connected to the network 10. Thus, the various types of information acquired by the accommodation function switching unit 70 and the identity verifying unit 80 described above are first stored in the guest information database 46c of the vehicle 40. Then, when the vehicle 40 and the network 10 are connected, the guest information in the user information database 24b of the vehicle managing device 20 may be updated with the updated guest information in the guest information database 46c.

User Terminal Device

A user terminal device 50 as a user terminal is operated by a user. The user terminal device 50 transmits various types of information such as user information including user identification information and user selection information to the vehicle managing device 20 for example by various types of data or a call using sound by a communication application. The user identification information includes information such as a user ID and a password necessary for accessing the vehicle managing device 20 upon transmission of the user information. The user terminal device 50 is capable of receiving various types of information such as operation plan information, vehicle assignment approval signal, and electronic key data from the vehicle managing device 20. FIG. 8 is a block diagram schematically illustrating a configuration of a user terminal device 50.

As illustrated in FIG. 8, the user terminal device 50 includes an electronic control unit 51, an input unit 52, a display unit 53, a communication unit 54, and a storage unit 55 that are connected to allow communication with each other. The electronic control unit 51 is configured with the main components thereof being a microcomputer including a CPU, a ROM, a RAM, etc. The electronic control unit 51 integrally controls the operations of the input unit 52, the display unit 53, the communication unit 54, and the storage unit 55 by executing various application programs.

The input unit 52 includes, for example, a keyboard or a touch panel type keyboard incorporated in the display unit 53 to detect a touch operation of the display panel, or a sound input device enabling an external phone call. Here, the external phone call is specifically, for example, a call with an operator or an artificial intelligence system residing in the vehicle managing device 20. The display unit 53 includes, for example, an organic EL panel, a liquid crystal display panel, or the like and externally notifies information by displaying characters, figures, and the like on the display panel.

The communication unit 54 connects to the network 10 and implements a function of transmitting and receiving various types of information such as user identification information, user selection information, operation plan information, and voice data to and from the vehicle managing device 20. The storage unit 55 stores various application programs including an operating system (OS) allowing the electronic control unit 51 to integrally control the operation of the user terminal device 50, a vehicle assignment application (hereinafter referred to as a vehicle assignment app), and various types of data. The storage unit 55 is capable of storing user identification information.

As the above-described user terminal device 50, specifically, a mobile phone such as a smartphone, an information terminal such as a tablet type, a personal computer, or the like can be adopted. Note that a desktop type personal computer installed at home or other premises, a fixed-line telephone installed at home or other premises, or the like can also be used.

Processing Method of Assigning Vehicle

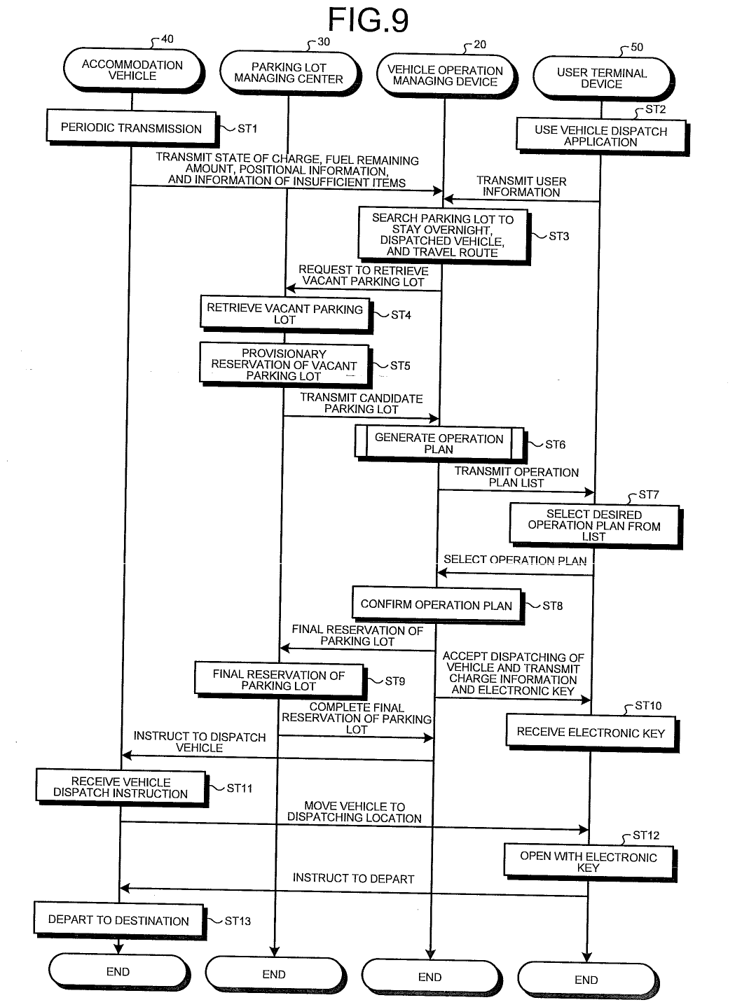

Next, a vehicle assigning processing method including generation of an operation plan according to an embodiment of the present disclosure by the vehicle managing system 1 configured as described above will be described. FIG. 9 is a flowchart for explaining a processing method by the vehicle managing system 1.

As illustrated in FIG. 9, first in step ST1, various types of information related to the vehicles 40 is periodically transmitted from each of the plurality of vehicles 40 to the vehicle managing device 20. Here, the term “periodic” means every predetermined period of time such as every hour or every three hours. Note that, in the following description, transmission and reception of information is performed via the network 10; however, explanation as such on each item is omitted. The vehicle management control unit 23 of the vehicle managing device 20 stores vehicle information received via the communication unit 21 and the communication interface 25 in the storage unit 24 in association with the vehicle identification information of each of the vehicles 40.

Meanwhile, in step ST2, operation of the user terminal device 50 by the user results in activation of the vehicle assignment app (application) in the user terminal device 50. Note that step ST2 is executed independently of step ST1. The vehicle assignment app is activated and executed on the basis of an operation program such as an operating system (OS) stored in the user terminal device 50. The user terminal device 50 in which the vehicle assignment app is executed transmits user identification information input by the user or stored in the user terminal device 50 to the vehicle managing device 20. Hereinafter, in the user terminal device 50, transmission and reception of various types of information and storage of information in the storage unit 55 or other components upon use of the vehicle managing system 1 is executed by the vehicle assignment app as appropriate.

The user terminal device 50 transmits user selection information input by the user using the user terminal device 50 to the vehicle managing device 20 as user information. Note that the user selection information selectively contains necessary information out of: boarding positional information including a boarding location that the user desires; alighting positional information including an alighting location; boarding/alighting positional information including boarding positional information and alighting positional information; boarding time information including boarding time; alighting time information including alighting time; and overnight stay timing information including an overnight stay timing. The overnight stay timing indicates that a parking lot 60 where the user wishes to stay overnight is closer to the boarding location or the alighting location, in this embodiment. Namely, an overnight stay timing closer to the boarding location is regarded as being before traveling to (arriving at) the alighting position, whereas an overnight stay timing closer to the alighting location is regarded as being after traveling to (arriving at) the alighting position. The overnight stay timing information includes information as to before or after traveling to the alighting position selected by the user. The vehicle management control unit 23 of the vehicle managing device 20 stores the user selection information received via the communication unit 21 and the communication interface 25 in the storage unit 24 in association with each piece of the user identification information.

Thereafter, in step ST3, the vehicle managing device 20 searches for a vehicle 40 to be assigned to the user, a parking lot 60 where to stay overnight (also referred to as an overnight stay parking lot 60), and a traveling route on the basis of the received vehicle information and the user information. Here, the overnight stay parking lot is a parking lot 60 to park at for the user or other people to stay overnight in the retrieved vehicle 40. The vehicle 40 to be assigned is a vehicle 40, out of the respective vehicles 40, which is moved such that the user can board. The traveling route is a traveling route on accessible roads which is selected depending on the purpose-specific traveling pattern of the traveling of the vehicle 40 on the basis of the user selection information transmitted from the user terminal device 50. The vehicle management control unit 23 searches for a time period during which the vehicle 40 is parked in the overnight stay parking lot 60 on the basis of the searched traveling route. The vehicle managing device 20 transmits, to the parking lot managing center 30, a search request signal for an overnight stay parking lot (hereinafter referred to as an vacant parking lot) where the vehicle 40 can be parked during the time period which is located along the searched traveling route.

After step ST3, the vehicle managing device 20 transmits a search request signal for a vacant parking lot to the parking lot managing center 30. As a result, in step ST4, the parking lot management control unit 33 of the parking lot managing center 30 retrieves vacant parking lots located along the traveling route on the basis of the search request signal for a vacant parking lot received from the vehicle managing device 20 and the time period of parking of the vehicle 40. Note that the parking lot managing center 30 stores the received parking lot information in the parking lot management database 34a of the storage unit 34 as necessary in association with the parking lot identification information of each of the parking lots 60.

Subsequently, in step ST5, the parking lot managing center 30 transmits parking reservation information to a vacant parking lot to make a so-called provisionary reservation in order to temporarily disable reservation of the searched vacant parking lot by another vehicle at time and the time period to park in the parking lot on the basis of the traveling route of the vehicle 40. Here, the parking reservation information includes parking start time when parking of the vehicle 40 in the parking lot 60 starts, parking end time to depart from the parking lot, parking position information for selecting a position to park in the parking lot 60, and so on. Note that the parking reservation information may include other information. The parking lot managing center 30 transmits the list information of the plurality of vacant parking lots (hereinafter referred to as candidate parking lots) where the aforementioned provisional reservation has been made to the vehicle managing device 20.

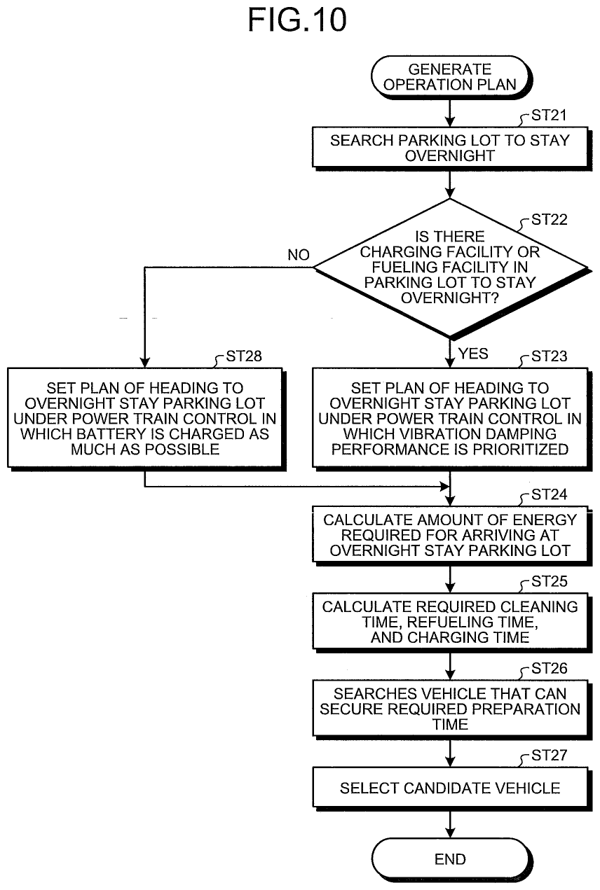

Thereafter, in step ST6, the vehicle managing device 20 generates a plurality of operation plans. Here, a specific example of a method of generating an operation plan will be described. FIG. 10 is a flowchart for explaining a method of generating the operation plan illustrated in FIG. 9.

As illustrated in FIG. 10, in the method of generating an operation plan according to this embodiment, the vehicle management control unit 23 first, in step ST21, searches parking lot information of the overnight stay parking lot 60 from the operation management database 24a of the storage unit 24 on the basis of the list information of candidate parking lots received from the parking lot managing center 30. As described above, the parking lot information includes various types of information such as positional information, battery charging facility information, fueling facility information, reservation state information, and parking state information of at least each of the parking lots 60.

Next, moving on to step ST22, the vehicle management control unit 23 determines whether at least one of a battery charging facility and a fueling facility exists is available in the overnight stay parking lot 60 on the basis of the parking lot information of the searched overnight stay parking lot 60. If it is determined that a battery charging facility or a fueling facility is available in the searched overnight stay parking lot 60, the vehicle management control unit 23 proceeds to step ST23.

In step ST23, the vehicle management control unit 23 sets to perform power train control, which is travel control in which vibration damping performance is prioritized, in the vehicle 40 on the basis of the traveling route searched in the above step ST3. In this manner, a plurality of operation plans is planned that can ensure vibration damping performance as much as possible in the vehicle 40.

Next, the flow proceeds to step ST24. In step ST24, the vehicle management control unit 23 calculates the amount of energy required from the departing location to the overnight stay parking lot on the basis of the plurality of operation plans set to perform the power train control in which vibration damping performance is prioritized. Then, moving on to step ST25, the vehicle management control unit 23 calculates required cleaning time, refueling time, and battery charging time (hereinafter referred to as “required preparation time”) for each of the vehicles 40 on the basis of the vehicle information received from each of the vehicles 40 in the above step ST1. The calculated required preparation time for each of the vehicles 40 is stored in the operation management database 24a.

Thereafter, the flow proceeds to step ST26. In step ST26, the vehicle management control unit 23 searches for a vehicle 40 that can secure the calculated required preparation time on the basis of the received vehicle information. Then in step ST27, the vehicle management control unit 23 selects at least one vehicle 40 as a candidate vehicle 40 that the user can use out of the searched vehicles 40. The vehicle management control unit 23 includes the information of the candidate vehicle 40 in the operation plan information.

On the other hand, if it is determined that neither a battery charging facility nor a fueling facility is available in the searched overnight stay parking lot in step ST22, the vehicle management control unit 23 proceeds to step ST28. In step ST28, the vehicle management control unit 23 sets to perform the power train control, which is travel control that suppresses reduction of the state of charge by charging the battery as much as possible in the vehicle 40 on the basis of the traveling route searched in the above step ST3. In other words, the accommodation vehicle 40 includes a rechargeable battery, and in the case where neither a facility capable of charging the battery nor a facility capable of refueling the accommodation vehicle 40 is available in the overnight stay parking lot selected in the operation plan, the travel control in the operation plan is set to suppress consumption of the electric power from the battery in the accommodation vehicle 40. The vehicle management control unit 23 plans a plurality of operation plans that allows the battery in the vehicle 40 to be charged as much as possible. The operation plan in this case implements in the vehicle 40 a plan to use at least one of the electric power and fuel that enables maintaining a state where the engine of the vehicle 40 is not used during a preset time period such as a bedtime. In other words, the accommodation vehicle 40 includes an engine capable of generating electricity, and the operation plan includes a plan to use at least one of the electric power and fuel that enables maintaining a state where the engine is not used during a preset time period. That is, the vehicle management control unit 23 plans an operation plan in which the state of charge of the battery of the vehicle 40 does not reach zero for a set time while the vehicle 40 is parked in the overnight stay parking lot 60.

Thereafter, moving on to step ST24, the vehicle management control unit 23 calculates the amount of energy required from the departing location to the overnight stay parking lot on the basis of the plurality of operation plans set to perform power train control under which the battery is charged as much as possible. Then, steps ST25 to ST27 are similar to the above-described processing. The operation plan list, which is information of the plurality of operation plans planned in the above manner, is transmitted to the user terminal device 50 after step ST6 in FIG. 9. Along with this, the vehicle managing device 20 transmits charge information corresponding to each of the operation plans in the operation plan list to the user terminal device 50.

Subsequently, in step ST7, the user selects a desired operation plan from a plurality of operation plans in the user terminal device 50. Here, charge information depending on the operation plan is also transmitted to the user terminal device 50. An example of this charge information is charge information based on the above-described table of charges illustrated in FIG. 3.

Here, the charge information will be described. In the example of the charge information illustrated in FIG. 3, for example, eight charge levels of S1, S2, A1, A2, B1, B2, C1, and C2 are set as charges. These charge levels can be defined as, for example, S1>S2>A1>A2>B1>B2>C1>C2. Specifically explaining an example, in the case where a boarding location in a suburb and an alighting location is in a city center, and parking the vehicle 40 in a suburban parking lot 60 is more reasonable as compared to parking the vehicle 40 in a city center parking lot 60, as for an overnight stay timing, the charge can be lower for an overnight stay with the vehicle 40 parked in the suburban parking lot 60 before traveling. Furthermore, as for parking lots 60 for parking the vehicle 40 at times of staying overnight or for other activities in suburbs, there are cases where a parking fee is more reasonable for parking lots such as coin-operated parking (suburban P in FIG. 3) than parking lots of stores (suburban store P in FIG. 3). Therefore, depending on which of parking lots 60 having different parking fees the overnight stay parking lot corresponds to, charges corresponding to those parking fees can be set. Note that the store P includes parking lots of commercial facilities such as hot spring facilities, supermarkets, shopping malls, amusement parks, manga cafés, movie theaters, night clubs, and gas stations. In addition, in the case where the store P is selected as the parking lot 60 to be used at the time of staying overnight or for other activities, it is also possible to collect introduction fee or the like from the commercial facility of the store P. Furthermore, the charge setting may vary depending on the days of the week. For example, it is possible to set the charges higher for cases where a boarding day or an alighting day is a holiday than for cases a boarding day or an alighting day is a weekday.

In and after step ST7, the operation plan information selected by the user is transmitted from the user terminal device 50 to the vehicle managing device 20 together with the user identification information. Thereafter, in step ST8, the vehicle managing device 20 performs processing of confirming the operation plan on the basis of the received user identification information and the selected operation plan information. The confirmed operation plan information is stored in the operation management database 24a in association with the user identification information.

The vehicle managing device 20 transmits, to the parking lot managing center 30, reservation information including information of a so-called final reservation that ensures a state where the vehicle 40-for the user can park in the parking lot at a predetermined time point and a time period based on the operation plan on the basis of parking lot information included in the operation plan selected by the user. As a result, in step ST9, the parking lot managing center 30 makes a so-called final reservation that prevents other vehicles from making a reservation at the time point and the time period when the vehicle 40 parks in the parking lot on the basis of the operation plan of the vehicle 40. The reservation information is stored in the parking lot management database 34a in association with the vehicle identification information of the vehicle 40. The parking lot managing center 30 switches the provisionally reserved parking lot described above to a vacant parking lot that allows other vehicles to park at the date and time and the time period which have been initially provisionally reserved. The parking lot managing center 30 transmits a signal indicating completion of the final reservation of the parking lot to the vehicle managing device 20.

Meanwhile, after the operation plan has confirmed, the vehicle managing device 20 transmits a vehicle assignment approval signal for approval of assigning the vehicle 40 selected by the user, charge information, and electronic key data to the user terminal device 50. In step ST10, the user terminal device 50 receives the electronic key data. Here, the electronic key functions as a release key in the user terminal device 50 for entering the vehicle 40 to drive or use the vehicle 40 by various communication means such as Bluetooth (registered trademark) and near field communication (NFC).

Upon receipt of the signal indicating completion of the final reservation of the parking lot 60, the vehicle managing device 20 transmits a signal of vehicle assignment instruction to the vehicle 40 selected by the user. In step ST11, the vehicle 40 receives information of the vehicle assignment instruction. Then, a predetermined worker or another person moves the vehicle 40 to an assigning location, that is, the boarding location of the user. Thereafter, in step ST12, the user unlocks the assigned vehicle 40 using the electronic key data in the user terminal device 50 to instruct the vehicle 40 to depart. Thereafter, in step ST13, the user gets in the vehicle 40 and departs to the alighting location which is the destination in accordance with the operation plan information generated in step ST6.

Here, the capacity and the maximum accommodatable number of guests are usually different in the accommodation vehicles 40. Therefore, in the case where the capacity of the vehicle 40 is larger than the maximum accommodatable number of guests according to the laws and regulations at the time point when the user gets in the vehicle 40 and departs toward the destination, the control unit 44 supplies, to the input/output unit 47, information indicating that the capacity is larger than the maximum accommodatable number of guests according to the laws and regulations to notify the user. Note that the timing of notifying the user can vary and is not necessarily limited to the point of departure.

In the above manner, the vehicle 40 can be assigned and moved by the vehicle managing system 1. Thereafter, as the operation plan from the boarding location to the alighting location, the vehicle 40 heads to the overnight stay parking lot under either the power train control for charging the battery as much as possible or the power train control giving priority to the vibration damping performance.

According to the processing method of assigning a vehicle of the embodiment described above, as an operation plan generated by the vehicle managing device 20, a plan for consuming electric power in the battery of the vehicle 40 and consuming fuel in the engine of the vehicle 40 can be generated depending on the facilities in the parking lot 60 to park at the time of staying overnight or for other activities, and thus this can reduce the possibility that the electric power of the battery of the vehicle 40 runs short while the user is staying overnight inside the vehicle 40.

Processing for Confirming the Number of Guests

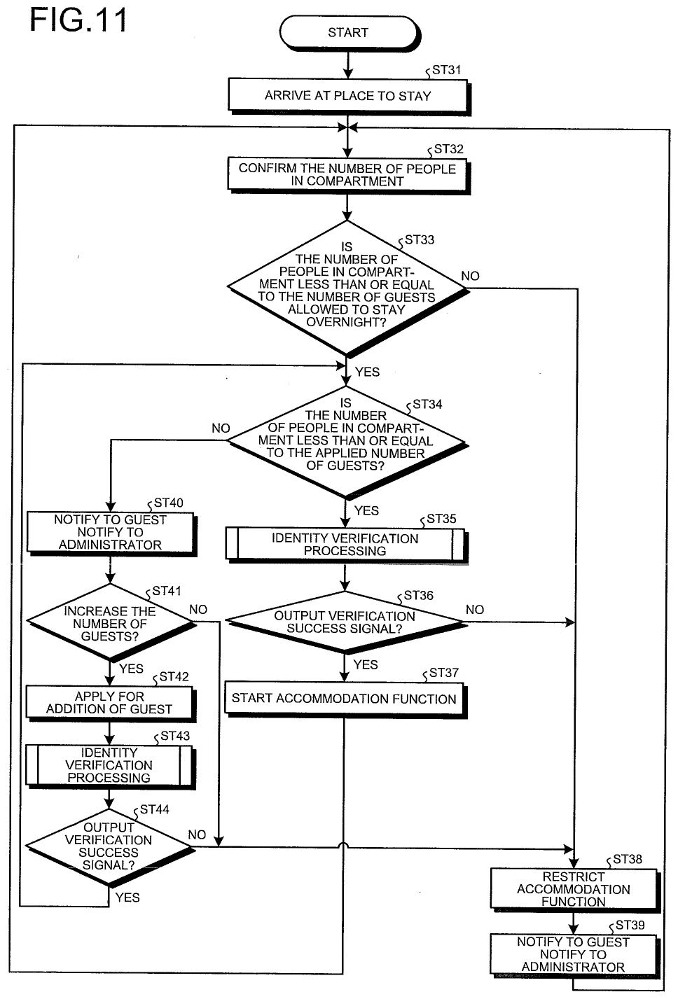

When the vehicle 40 travels to and arrives at the place to stay such as the predetermined overnight stay parking lot, processing for confirming the number of guests is executed. Next, processing for confirming the number of guests according to an embodiment of the present disclosure will be described. FIG. 11 is a flowchart illustrating a processing method for confirming the number of guests.

As illustrated in FIG. 11, when the vehicle 40 on which the user is onboard arrives at the place to stay in step ST31, the flow proceeds to step ST32, and the number of people in the compartment of the vehicle 40 is confirmed. That is, measurement data of the number of people in the compartment measured by the compartment interior sensor 43 is supplied to the number-of-people acquiring unit 71 of the accommodation function switching unit 70. The number-of-people acquiring unit 71 confirms the number of people in the compartment and supplies the in-compartment number-of-people information to the accommodation availability determining unit 72. Thereafter, the flow proceeds to step ST33.

In step ST33, the accommodation availability determining unit 72 determines whether the number of people in the compartment in the supplied in-compartment number-of-people information is less than or equal to the maximum number of people in the accommodatable maximum number-of-guests information 91. If it is determined that the number of people in the compartment is less than or equal to the maximum number of people (step ST33: Yes), the accommodation availability determining unit 72 supplies the in-compartment number-of-people information to the number-of-guests determining unit 73, and the flow proceeds to step ST34.

In step ST34, the number-of-guests determining unit 73 determines whether the number of people in the compartment is less than or equal to the applied number of guests in the pre-applied guest information 92. If it is determined that the number of people in the compartment is less than or equal to the applied number of guests (step ST34: Yes), the number-of-guests determining unit 73 supplies the guest nationality information 93 and a verification request signal to the identity verifying unit 80, and the flow proceeds to step ST35. In step ST35, the identity verifying unit 80 performs collation confirmation with the applied guests for the passengers of the vehicle 40.

Processing Method for Identity Verification

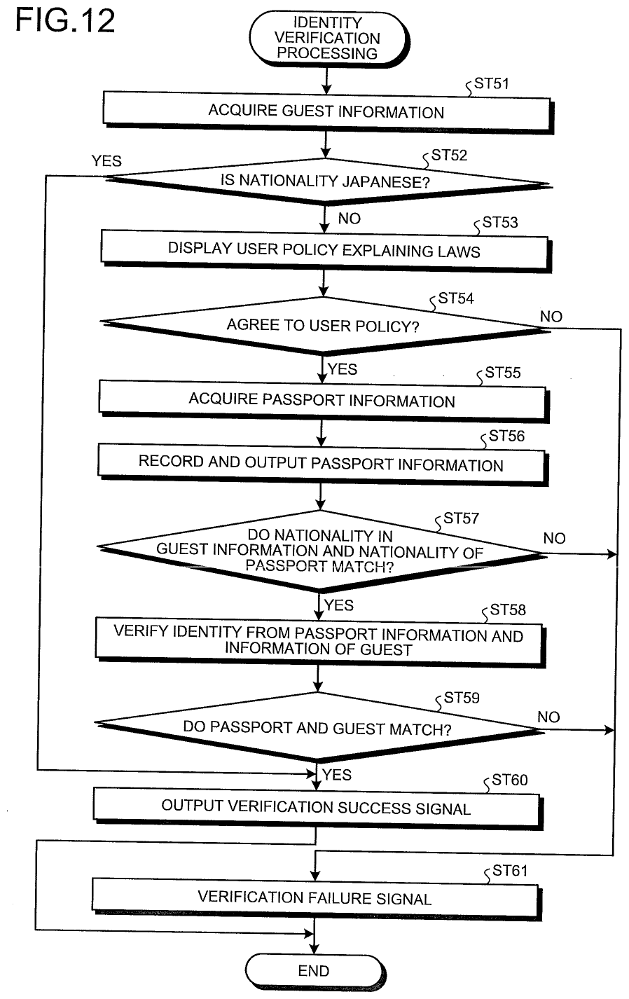

Here, a processing method for identity verification by the identity verifying unit 80 will be described. FIG. 12 is a flowchart for explaining the processing method for identity verification according to an embodiment. As illustrated in FIG. 12, in the processing method for identity verification according to this embodiment, in step ST51, the nationality determining unit 81 in the identity verifying unit 80 is supplied with the guest nationality information 93 of the guest stored in the guest information database 46c.

Next, in step ST52, the nationality determining unit 81 determines whether the nationality of the guest is the nationality of the country in which the vehicle 40 is used, in this example, Japan, on the basis of the supplied guest nationality information 93. When it is determined that the nationality of the guest is not Japanese (step ST52: No), the nationality determining unit 81 supplies a foreign nationality collation signal to the user policy acceptance unit 82, and the flow proceeds to step ST53.

In step ST53, the user policy acceptance unit 82 displays a user policy explaining laws or regulations. That is, the user policy acceptance unit 82 outputs, from the input/output unit 47, information indicating the necessity of confirmation of the passport and verification of the identity in accordance with laws and ordinances as well as information inquiring whether to agree to presentation of the passport and disclosure of personal information, and the flow to step ST54.

If the guest inputs information, using the input/output unit 47, to the effect that the guest agrees to presentation of the passport and disclosure of personal information in step ST54 (step ST54: Yes), the user policy acceptance unit 82 supplies a user policy agreement signal to the passport information acquiring unit 83, and the flow proceeds to step ST55.

In step ST55, the passport information acquiring unit 83 outputs, to the input/output unit 47, information prompting the guest to input passport information. When the guest supplies passport information to the passport information acquiring unit 83 by using the imaging unit 49, in step ST56, the passport information acquiring unit 83 stores the supplied passport information in the guest nationality information 93 and supplies the passport information to the collation confirming unit 84, and the flow proceeds to step ST57.

In step ST57, the collation confirming unit 84 determines whether nationality information of the guest in the pre-applied guest information 92 matches the nationality information in the input passport information. If the collation confirming unit 84 determines that the nationality information of the guest matches the nationality information of the passport information (step ST57: Yes), the flow proceeds to step ST58.

In step ST58, the collation confirming unit 84 outputs information prompting provision of information necessary for predetermined biometric authentication from the input/output unit 47. When the guest supplies information necessary for the biometric authentication to the collation confirming unit 84, the flow proceeds to step ST59.

In step ST59, the collation confirming unit 84 compares the supplied biometric authentication information of the guest with the passport information and determines whether the supplied biometric authentication information corresponds to the person in the passport information. If the supplied biometric authentication information corresponds to the person in the passport information (step ST59: Yes), the flow proceeds to step ST60, and the collation confirming unit 84 outputs a verification success signal to either one of the number-of-guests determining unit 73 and the additional guest confirming unit 74 of the accommodation function switching unit 70, namely to the one which has output the verification request signal. In the above manner, the identity verification processing completes.

Next in step ST52, if the nationality determining unit 81 determines that the nationality of the guest is Japanese on the basis of the supplied guest nationality information 93 (step ST52: Yes), the flow proceeds to step ST60. In step ST60, the nationality determining unit 81 outputs a verification success signal to either one of the number-of-guests determining unit 73 and the additional guest confirming unit 74, namely to the one which has output the verification request signal.

Contrarily, if the guest inputs information, using the input/output unit 47, to the effect that the guest disagrees to presentation of the passport and disclosure of personal information in step ST54 (step ST54: No), the flow proceeds to step ST61. In step ST61, the user policy acceptance unit 82 outputs a verification failure signal to either one of the number-of-guests determining unit 73 and the additional guest confirming unit 74, namely to the one which has output the verification request signal.
Furthermore, the user policy acceptance unit 82 may supply, to the vehicle managing device 20 via the network 10, information indicating that the nationality information of the guest does not match the nationality information of the input passport information, or information indicating that the supplied biometric authentication information does not correspond to the person in the passport information.

If the collation confirming unit 84 determines that the nationality information of the guest does not match the nationality information of the input passport information in step ST57 (step ST57: No), or if the collation confirming unit 84 determines that the supplied biometric authentication information does not correspond to the person in the passport information in step ST59 (step ST59: No), the flow proceeds to step ST61. In step ST61, the collation confirming unit 84 outputs a verification failure signal to either one of the number-of-guests determining unit 73 and the additional guest confirming unit 74, namely to the one which has output the verification request signal. Furthermore, the collation confirming unit 84 may supply, to the vehicle managing device 20 via the network 10, information indicating that the nationality information of the guest does not match the nationality information of the input passport information, or information indicating that the supplied biometric authentication information does not correspond to the person in the passport information. As described above, the identity verifying unit 80 outputs the verification success signal or the verification failure signal to the accommodation function switching unit 70 and terminates the identity verification process in step ST35 illustrated in FIG. 11.

Thereafter, the accommodation function switching processing proceeds to step ST36 illustrated in FIG. 11. In step ST36, the number-of-guests determining unit 73 determines whether the identity verifying unit 80 has output the verification success signal. If it is determined that the identity verifying unit 80 has output the verification success signal (step ST36: Yes), the number-of-guests determining unit 73 supplies an accommodation provision signal to the accommodation function start control unit 75, and the flow proceeds to step ST37.

In step ST37, the accommodation function start control unit 75 to which the accommodation provision signal has been supplied supplies a use restriction release signal for releasing restriction on the use to the accommodation function unit 42. The accommodation function unit 42, to which the use restriction release signal, enters a state in which various facilities necessary for staying overnight are available including the bedding. Thereafter, the accommodation function start control unit 75 returns to step ST2 periodically at predetermined time intervals or at every predetermined trigger to control the number-of-people acquiring unit 71 to count the number of people in the compartment. In the above manner, the accommodation function switching processing completes.

In addition, if the accommodation availability determining unit 72 determines that the number of people in the compartment is greater than the maximum number of people in step ST33 (step ST33: No), the flow also proceeds to step ST38. In this case, since no accommodation provision signal is supplied from the accommodation availability determining unit 72 to the number-of-guests determining unit 73, the use restriction release signal is not output from the accommodation function start control unit 75, and the restriction on the use of the accommodation function unit 42 is maintained. Thereafter, the flow proceeds to step ST39, in which information indicating that accommodation cannot be provided for the current number of people in the compartment is output from the input/output unit 47, and information indicating that the number of people in the compartment is greater than the maximum number of people is supplied to the vehicle managing device 20 via the network 10. The flow then returns to step ST32.

Contrarily, if the number-of-guests determining unit 73 determines that the number of people in the compartment is larger than the applied number of guests in step ST34 (step ST34: No), the flow proceeds to step ST40.

In step ST40, the number-of-guests determining unit 73 supplies information indicating that the number of people in the compartment is greater than the applied number of guests to the vehicle managing device 20 via the network 10. In addition to this, an accommodation denial signal is supplied to the additional guest confirming unit 74, and information of accommodation denial indicating that the current number of people in the compartment is greater than the number of applied guests is output from the input/output unit 47. The additional guest confirming unit 74 further outputs information whether to increase the number of guests from the input/output unit 47. Thereafter, the flow proceeds to step ST41.

In step ST41, a determination as to whether the user increases the number of guests is input to the additional guest confirming unit 74 by the input/output unit 47. When the user inputs a selection to increase the number of guests from the input/output unit 47 (step ST41: Yes), the flow proceeds to step ST42.

In step ST42, the additional guest confirming unit 74 causes the input/output unit 47 to output information prompting input of information necessary for generating a guest list conforming to laws and ordinance (or the Inns and Hotels Act). When the user inputs information necessary for generation of a guest list for the number of people to be increased from the input/output unit 47, the additional guest confirming unit 74 stores the input information to the pre-applied guest information 92 and the guest nationality information 93 for an update.

Thereafter, the flow proceeds to step ST43, in which the additional guest confirming unit 74 supplies a verification request signal to the identity verifying unit 80 on the basis of the updated guest nationality information 93. The identity verifying unit 80 to which the verification request signal is supplied performs collation confirmation of the guest in a similar manner to step ST35. Thereafter, the flow proceeds to step ST44.

In step ST44, like in step ST36, the additional guest confirming unit 74 determines whether a verification success signal has been output from the identity verifying unit 80. If the additional guest confirming unit 74 determines that the identity verifying unit 80 has output the verification success signal (step ST44: Yes), the flow returns to step ST34. The processing of steps ST34 and ST40 to ST44 is repeatedly executed until the number of people in the compartment becomes less than or equal to the applied number of guests in the updated pre-applied guest information 92 (step ST34: Yes). In the above manner, the accommodation function switching processing completes.

According to the above-described embodiment, in the case where the number of passengers in the compartment of the accommodation vehicle 40 is larger than the number of accommodatable guests conforming to laws and ordinances, continued restriction on the use of the accommodation function allows the accommodation vehicle 40 to conduct operation conforming to laws and ordinances such as the Inns and Hotels Act.

Furthermore, as an operation plan generated by the vehicle managing device 20, a plan for consuming electric power in the battery of the vehicle 40 and consuming fuel in the engine of the vehicle 40 can be generated depending on the facilities in the parking lot 60 to park at the time of staying overnight or for other activities, and thus this can reduce the possibility that the electric power of the battery of the vehicle 40 runs short while the user is staying overnight inside the vehicle 40.

Although the embodiment of the present disclosure has been specifically described above, the present disclosure is not limited to the embodiment described above, and various modifications based on the technical idea of the present disclosure may be employed. For example, the configurations of the respective devices described in the above embodiment is merely an example, and a configuration different from the above may be used as necessary.

For example, information transmitted and received among the vehicle managing device 20, the parking lot managing center 30, the respective vehicles 40, and the respective user terminal devices 50 according to the embodiment described above is not necessarily limited to the information described above, and information different from the above may be transmitted and received as necessary.

For example, the vehicles 40 used in the embodiment described above may include various accommodation vehicles as long as staying overnight in the vehicle is possible, and may include an accommodation vehicle that can be automatically operated, an accommodation vehicle operated by another driver, a lodging bus or a large-sized vehicle in which staying overnight is possible, etc. Moreover, the vehicle 40 may be of any type including a hybrid vehicle having both an engine and a motor, a conventional vehicle having an engine but without a motor, and an EV vehicle having a motor but without an engine.

Furthermore, the processing method of assigning a vehicle by the vehicle managing system 1 that is executed according to the above embodiment is not limited to the order mentioned above, and the order of the steps can be modified as long as the processing method of assigning a vehicle can be executed. For example, the transmission of the vehicle assignment approval signal, the charge information, and the electronic key data may be performed after the final reservation of the overnight stay parking lot 60 is completed.

In the embodiment described above, the example has been described in which, a plan for consuming electric power in the battery of the vehicle 40 and consuming fuel in the engine of the vehicle 40 is generated depending on the facilities in the parking lot 60 to park at the time of staying overnight or for other activities; however, this is not necessarily limited to the case of staying overnight. Specifically, the present disclosure can be similarly applied to a case where an accommodation vehicle is stopped at a predetermined parking lot and a driver or other passengers perform other works. In addition, the time period during which the vehicle 40 is parked is not necessarily limited to nighttime, and the present disclosure can be similarly applied even the case where the time period for parking is daytime.

According to an accommodation vehicle managing device, an accommodation vehicle managing system, and an accommodation vehicle according to the present disclosure, in the case where the number of passengers in the accommodation vehicle is larger than the number of people who can be accommodated according to laws and ordinances, use of the accommodation function can be limited. This enables operation conforming to laws and ordinances in the accommodation vehicle.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An accommodation vehicle management apparatus comprising:
a transmitter/receiver configured to communicate with an accommodation vehicle where one or more guests may stay overnight;
a processor comprising hardware, wherein the processor is configured to
determine whether an actual number of guests in the accommodation vehicle is less than or equal to a predetermined number of guests who are allowed to utilize the accommodation vehicle by using bedding, and
output an allowance signal indicating allowance of usage of the bedding to the accommodation vehicle through the transmitter/receiver when it is determined that the actual number of guests in the accommodation vehicle is less than or equal to the predetermined number of guests.

2. The accommodation vehicle management apparatus according to claim 1, wherein the processor is further configured to
receive in advance a notification of the number of guests who are to utilize the accommodation vehicle by using bedding, through an input/output device provided in the accommodation vehicle;
determine whether the actual number of guests in the accommodation vehicle is greater than the number of guests in the notification received in advance; and
output information to request a re-notification of the number of guests who are to utilize the accommodation vehicle by using bedding, to the input/output device, when it is determined that the actual number of guests is greater than the number of guests in the notification.

3. The accommodation vehicle management apparatus according to claim 2, wherein the processor is further configured to receive from the accommodation vehicle the number of guests in the re-notification that has been stored in a memory provided in the accommodation vehicle, when communication between the accommodation vehicle management apparatus and the accommodation vehicle becomes available.

4. The accommodation vehicle management apparatus according to claim 2, wherein the processor is further configured to
receive information on nationality of each of guests of which number is notified in advance or re-notified
determine whether there is a guest whose nationality does not correspond to a country where the accommodation vehicle exists among the guests, in accordance with the received information on nationality;
output, to the input/output device, information requesting the guest whose nationality does not correspond to the country where the accommodation vehicle exists to input information prescribed in a passport of the guest to the input/output device, when it is determined that there is a guest whose nationality does not correspond to a country where the accommodation vehicle exists.

5. The accommodation vehicle management apparatus according to claim 4, wherein the processor is further configured to determine a language used in the input/output device in accordance with the nationality of the guest whose nationality does not correspond to the country where the accommodation vehicle exists, in accordance with the information on nationality or the information prescribed in the passport input to the input/output device.

6. The accommodation vehicle management apparatus according to claim 2, wherein the processor is further configured to output, to the input/output device, information indicating that the actual number of guests in the accommodation vehicle is greater than the predetermined number of guests who are allowed to utilize the accommodation vehicle by using bedding, when it is determined that the actual number of guests is greater than the predetermined number of guests.

7. The accommodation vehicle management apparatus according to claim 1, wherein the processor is further configured to
receive boarding/alighting location information from a terminal of a user who is to use the accommodation vehicle;
selecting a parking place of the accommodation vehicle in accordance with the boarding/alighting location information received from the terminal;
develop an operating plan including a usage plan of electric power or fuel to be consumed by the accommodation vehicle depending on a facility equipped in the parking place;
selecting the accommodation vehicle usable according to the operating plan;
calculating a charge to operate the selected accommodation vehicle according to the operating plan;
transmit information on the selected accommodation vehicle and the calculated charge to the terminal, wherein
the boarding/alighting location information includes alighting location information on an alighting location,
the charge is set to be different when the accommodation vehicle is parked for overnight staying in the alighting location from when the accommodation vehicle is parked for overnight staying before the accommodating vehicle arrives at the alighting location.

8. The accommodation vehicle management apparatus according to claim 1, wherein the predetermined number of guests is determined in compliance with laws, ordinances, or regulations established in a place where the accommodation vehicle is operated.

9. The accommodation vehicle management apparatus according to claim 6, wherein the predetermined number of guests is determined in compliance with laws, ordinances, or regulations established in a place where the accommodation vehicle is operated.

10. An accommodation vehicle management system comprising:
an accommodation vehicle where one or more guests may stay overnight; and
an accommodation vehicle management apparatus configured to manage operation of the accommodation vehicle, the accommodation vehicle management apparatus including:
a transmitter/receiver configured to communicate with the accommodation vehicle; and
a processor comprising hardware, wherein the processor is configured to
determine whether an actual number of guests in the accommodation vehicle is less than or equal to a predetermined number of guests who are allowed to utilize the accommodation vehicle by using bedding, and
output an allowance signal indicating allowance of usage of the bedding to the accommodation vehicle through the transmitter/receiver when it is determined that the actual number of guests in the accommodation-vehicle is less than or equal to the predetermined number of guests.

11. The accommodation vehicle management system according to claim 10, wherein the predetermined number of guests is determined in compliance with laws, ordinances, or regulations established in a place where the accommodation vehicle is operated.

12. An accommodation vehicle where one or more guests may stay overnight, the accommodation vehicle comprising a processor comprising hardware, wherein the processor is configured to
determine whether an actual number of guests in the accommodation vehicle is less than or equal to a predetermined number of guests who are allowed to utilize the accommodation vehicle by using bedding, and
output an allowance signal indicating allowance of usage of the bedding to an input/output device provided in the accommodation vehicle, when it is determined that the actual number of guests in the accommodation vehicle is less than or equal to the predetermined number of guests.

13. The accommodation vehicle according to claim 12, wherein the predetermined number of guests is determined in compliance with laws, ordinances, or regulations established in a place where the accommodation vehicle is operated.
